(19) United States
(12) Patent Application Publication
(10) Pub. No.: US 2009/0259578 A1
(43) Pub. Date: Oct. 15, 2009

(54) Customer exclusive data

(75) Inventor: Brian Maw, Belmont, CA (US)

Correspondence Address: Visa USA c/o Duane Morris LLP;Attn: James Sze, Esq., 101 West Broadway, Suite 900, San Diego, CA, 92101, US

(73) Assignee: Visa U.S.A. Inc.

(21) Appl. No.: 12/082,210

(22) Filed: Apr. 9, 2008

(51) Int. Cl. G06Q 40/00

(52) U.S. Cl. 705/35

(57) ABSTRACT

A payment device, method, and apparatus configured to store customer exclusive data on to a payment card or payment device.

### BACKGROUND

1. Field of the Invention

Aspects of the present disclosure relate in general to financial services. Aspects include an apparatus, system, method and computer-readable storage medium configured to record and identify customer exclusive data on a payment card or device.

2. Description of the Related Art

Traditionally, credit card issuers offer many different types of incentives to encourage card holders to use credit cards for their purchases. For example, some credit card issuers offer card holders frequent-flyer miles, cash back, or other combinations of rewards and rebates.

At the same time, issuers lack the ability to present card holders instant reward information.

### SUMMARY

Described embodiments include a system and method configured to record and identify customer exclusive data on a payment card or device. Despite the fact that the industry does not capture or utilize such information, one aspect of the invention includes the insight that tracking customer exclusive data used would be useful. A cardholder database contains primary account numbers of user accounts. Customer exclusive data may be associated with the primary account number. A customer data manager queries the cardholder database to determine whether there is customer exclusive data and send the customer exclusive data for storage on a payment device.

### BRIEF DESCRIPTION OF THE DRAWINGS

FIG. 1 illustrates an embodiment of a system configured to identify and/or record customer exclusive data on a payment card or device.

FIG. 2 is a block diagram of a payment processor configured to identify and/or record customer exclusive data on a payment card or device.

FIG. 3 is table showing an embodiment configured to store tags of information on a payment card or device.

FIGS. 4A and 4B illustrating storage of customer exclusive data on a payment card or device in Tag-Length-Value format.

FIG. 5 illustrates examples of customer exclusive data storage on a payment card or device.

FIG. 6 depicts device form factor information stored on a payment card or device.

FIG. 7 is a flow chart describing the initial storage of customer exclusive data on a payment card or device.

FIG. 8 is a flow chart showing the update of customer exclusive data on a payment card or device.

FIG. 9 is a flow chart showing the push update of customer exclusive data on a mobile payment device.

### DETAILED DESCRIPTION

Although the payment card industry does not currently capture or utilize customer exclusive data on a payment card or device, one aspect of the present includes the insight that tracking customer exclusive data in a financial transaction would be useful to consumers, card issuers, and card payment processors at the time of the transaction. First, card holders will be able to use customer exclusive data to identifier themselves, and therefore decrease fraudulent transactions. Issuers and payment processors may also use customer exclusive data to enable incentives for card holders at the time of the transaction, instead of days or weeks afterwards.

For the purposes of this document, a payment card may be any credit, debit, or financial transaction identification card capable of storing customer exclusive data.

A payment device may be any credit, debit, or financial transaction device, mobile phone, or identification card capable of storing customer exclusive data for use in a financial transaction.

A financial transaction is any operation involving a payment device, whether a payment, reimbursement, or any other interaction using a payment device. Financial transactions may be credit, debit, or charge transactions.

Embodiments of the present invention include a system, method, and computer-readable storage medium configured to record customer exclusive data on to a payment device used in a financial transaction. Other embodiments of the present invention may include remote terminals configured to capture, encode, or record the customer exclusive data information.

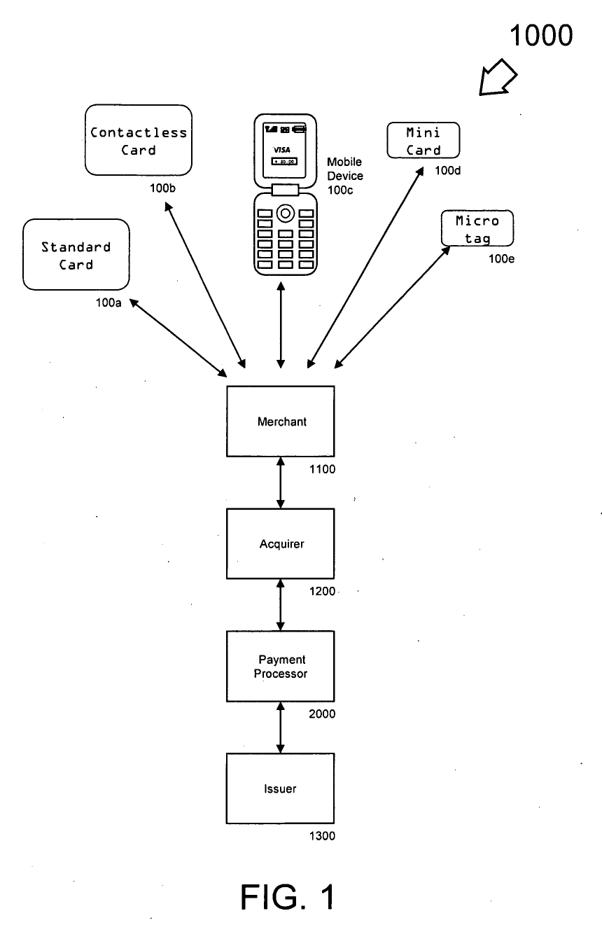

Turning to FIG. 1, this figure depicts system 1000, configured to record customer exclusive data information on to a payment device used in a financial transaction, constructed and operative in accordance with an embodiment of the present invention. In this example, payment device 100 may be any credit, debit, or charge device. Examples include, but are not limited to, a standard payment device 100a, a radio frequency (also known as “contactless” or “pay wave”) payment device 100b, a mobile phone device 100c, a mini-card 100d, micro tag 100e, payment fob, or any other payment device known in the art. It is understood that embodiments of the present invention may be extended to identify and track future payment devices.

When the consumer uses the payment device 100 at a merchant 1100 to pay for a product or service, the merchant 1100 contacts an acquirer 1200 (for example, a commercial bank) to determine whether the consumer is credit worthy or the account has sufficient funds on the card to pay for the transaction. The acquirer 1200 forwards the details of the payment transaction to a payment processor 2000 or payment card issuing bank 1300 (“the issuer”) for processing.

Payment processor 2000 may be any payment network known in the art. Examples of payment networks include Visa™, MasterCard™, and American Express™.

Issuer 1300 may be any financial institution or organization that issues the payment device 100.

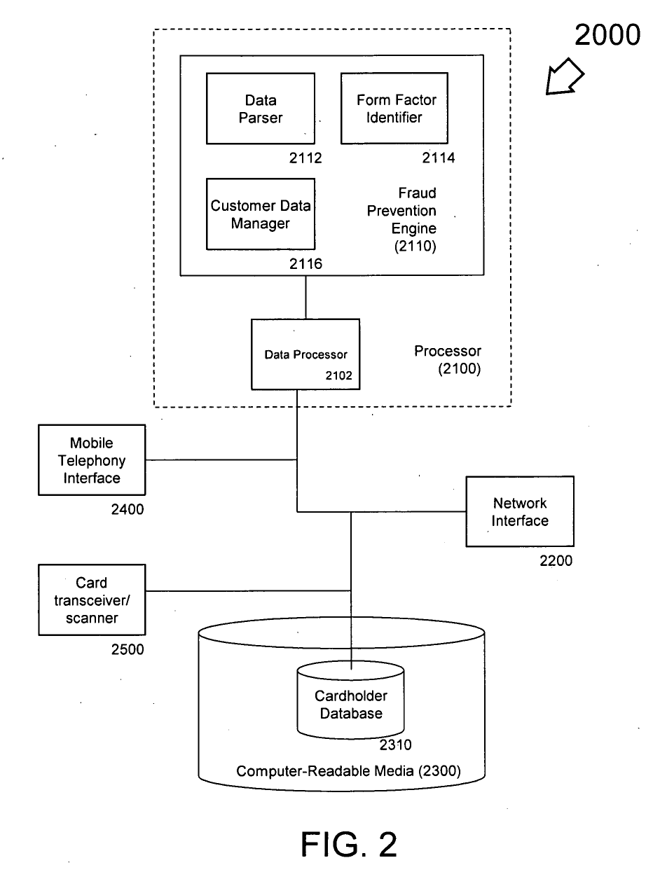

Embodiments will now be disclosed with reference to a payment processor 2000 depicted in FIG. 2, constructed and operative in accordance with an embodiment of the present invention. Payment processor 2000 is configured to encode customer exclusive data on a payment device 100. It is understood by others familiar with the art that merchant 1100, acquirer 1200 or issuer 1300 may be equivalently constructed to encode customer exclusive data on payment device 100. As an example only, payment processor 2000 is shown.

Payment processor 2000 may run a multi-tasking operating system (OS) and include at least one processor or central processing unit (CPU) 2100. Processor 2100 may be any central processing unit, microprocessor, micro-controller, computational device or circuit known in the art.

It is well understood by those in the art, that the functional elements of FIG. 2 may be implemented in hardware, firmware, or as software instructions and data encoded on a computer-readable storage medium 2300. As shown in FIG. 2, processor 2100 is functionally comprised of a fraud prevention engine 2110 and data processor 2102. Fraud prevention engine 2110 may further comprise: data parser 2112, form factor identifier 2114, and customer data manager 2116. These structures may be implemented as hardware, firmware, or software encoded on a computer readable medium, such as storage media 2300. The function of these is described further below.

Processor 2100 interfaces with storage medium 2300, network interface 2200, card transceiver/scanner 2500, and, in some embodiments, mobile telephony interface 2400. The data processor 2102 enables processor 2100 to locate data on, read data from, and writes data to, these components.

Network interface 2200 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2200 allows payment processor 2000 to communicate with issuer 1300, and may allow communication with acquirer 1200.

Computer-readable storage medium 2300 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Significantly, computer-readable storage medium 2300 may be remotely located from processor 2100, and be connected to processor 2100 via a network such as a local area network (LAN), a wide area network (WAN), or the Internet. In addition, as shown in FIG. 2, storage media 5300 may also contain cardholder database 2310. Note that in some embodiments, cardholder database may be located at merchant 1100, acquirer 1200, payment processor 2000, or issuer 1300.

Card transceiver/scanner 2500 may be any component known in the art capable of read/writing data to or from payment devices 100. For example, for conventional credit card 100a or mini-card 100d embodiments, card transceiver/scanner 2500 may read or write to a magnetic strip. Embodiments that communicate with a contactless card 100b, mobile phone 100c, and micro tag/key fob 100e include a wireless transceiver.

Mobile telephony interface 2400 is a wireless phone transceiver capable of communicating with mobile phone payment devices 100c. Wireless phone transceivers may communicate with any wireless telephony system known in the art. Such systems include, but are not limited to: digital cellular and personal communication systems (PCS). Message formats include, but are not limited to Enhanced Data Rates for Global Evolution (EDGE), General Packet Radio Service (GPRS) Wireless Internet (WAP), or any other mobile telephony standard known in the art.

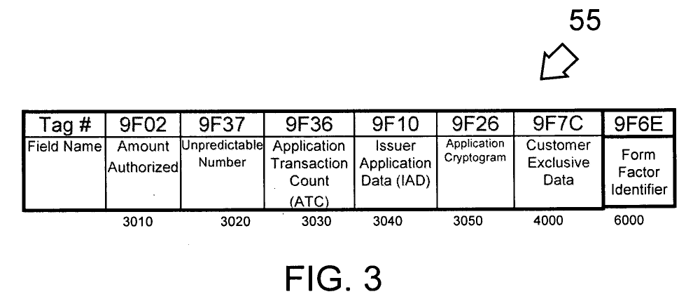

The function of these structures may best be understood with respect to FIGS. 3-9, as described below.

FIG. 3 depicts a data field 55 (also referred to as “Field 55”), constructed and operative in accordance with an embodiment of the present invention. Field 55 is a memory field on payment device 100 configured to store specific transaction information. In some embodiments, the memory field is in a computer chip within payment device 100. Although implementations of Field 55 may vary in size, in some embodiments may be limited to a maximum of 255 bytes of data. One of the features of Field 55 is the ability to allow unique personalization values in the authorization messages. These values are also known as tags (also known as “data elements”) in support of contactless transactions. Field 55 tags may include data embedded in the chip that the issuer requests to receive in the authorization message.

In one embodiment of Field 55, the Field 55 data elements may include: amount authorized 3010 (tag 9F02), unpredictable number 3020 (9F37), application transaction count (ATC) 3030 (tag 9F36), issuer application data (IAD) 3040 (tag 9F10), application cryptogram 3050 (tag 9F26), customer exclusive data 4000 (tag 9F7C), and form factor identifier 6000 (tag 9F6E). Tag 97FC carries customer exclusive data that issuer 1300 receives in an authorization request message during contactless transactions. For the purposes of this application, we need only address customer exclusive data 4000 and form factor identifier 6000.

A data parser 2112 associated with the fraud prevention engine is configured to parse and address the Field 55 data tags. In some embodiments, data parser 2112 further performs editing, storage, distribution, monitoring, and reporting functions.

Tag 9F7C (customer exclusive data 4000) is configured to allow transport and storage of a number of different issuer and cardholder specific information.

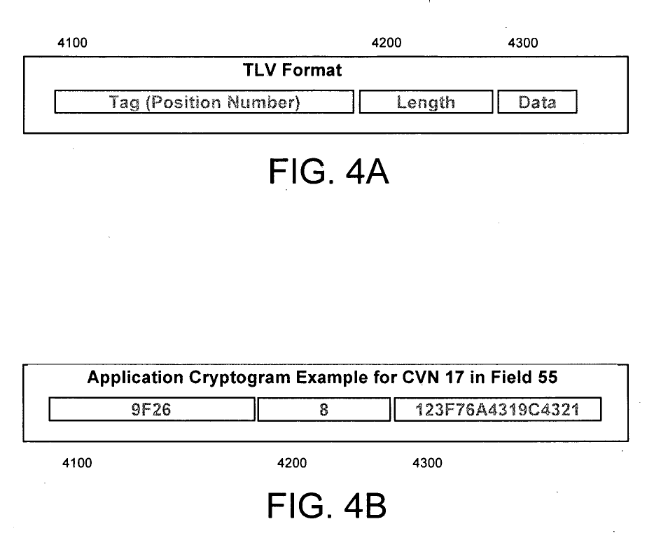

The data stored in Field 55 may be stored in any format known in the art. Some tag embodiments, as shown in FIGS. 4A and 4B store customer exclusive data 4000 and other data fields in Tag-Length-Value format, in accordance with an embodiment of the present invention. Tags 4100 indicate the position of the information, length 4200 indicates the length of the information, and a data field 4300 carries the information.

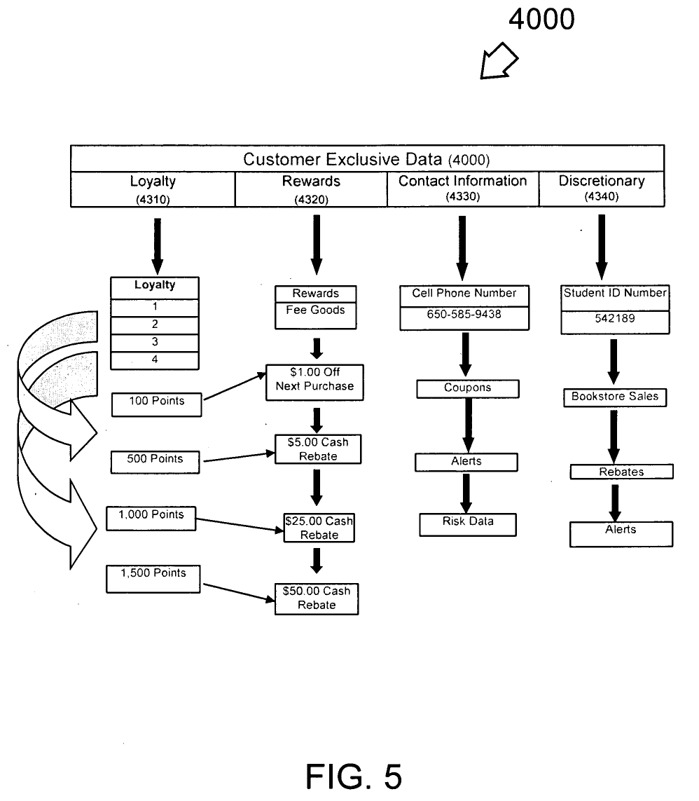

FIG. 5 illustrates examples of customer exclusive data 4000, in accordance with an embodiment of the present invention.

Examples of customer exclusive data 4000 include, but are not limited to:

Loyalty and Coupons 4100
Instant information regarding coupons to customers while in the check out line at specific merchants.

Rewards 4320
Instant reward information or after the fact rewards and rebates based on marketing campaigns.
Provides flexibility that enables immediate rewards experience for the customer or following a promotional period.

Alerts and Contact Information 4330
Available for cardholders who desire immediate knowledge of purchases over specific amounts or transactions conducted in any country.
Will provide the avenue necessary to establish contact with the cardholder at the point of sale, or thereafter, thus providing the capability to provide coupons, rewards, alerts, etc.
Mode of contact will utilize currently operational telephony systems and databases.

Other Types of Data Including Issuer Discretionary Data 4340
Risk Data
Student ID
Drivers License Number
Passport Number
Social Security Number
Library Card
Grocery club card or store card
Frequent Flyer Number
Hotel Rewards Number
Alternate Cell Phone
E-Mail Address
Birthday
Zip Code
Name of Pet
Type of Pet
Vehicle Information
Gas Card
Travel Preferences
Shopping Preferences
   Customer exclusive data 4000, as well as additional metrics, may be made available to the issuers 1300 via reports, which may be accessed on a subscription basis.

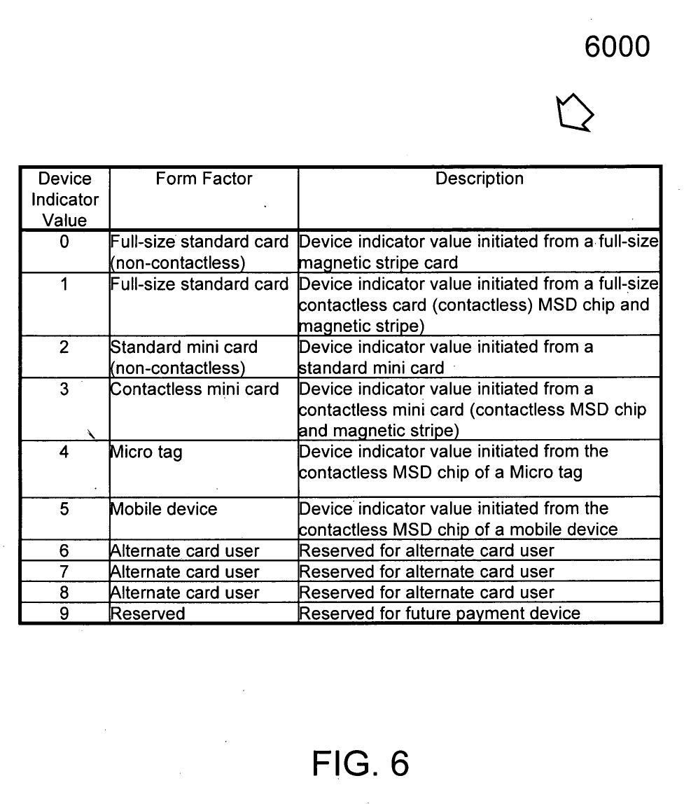

FIG. 6 depicts device form factor information stored on a payment card or device, in accordance with an embodiment of the present invention.

FIG. 6 illustrates a table showing device form factor information 6000 embodiment configured to identify the payment form factor used in a payment transaction, constructed and operative in accordance with an embodiment of the present invention. As shown, device indicator value 6000 reserves values contemplating use of full-size standard non-contactless payment cards 100a, a full-size contactless payment card 100b, a standard non-contactless mini card 100d, a contactless mini-card, a micro tag 100e, mobile device 100c, and alternate card users. It is understood that device indicator value 6000 embodiments may include some or all of such form factors.

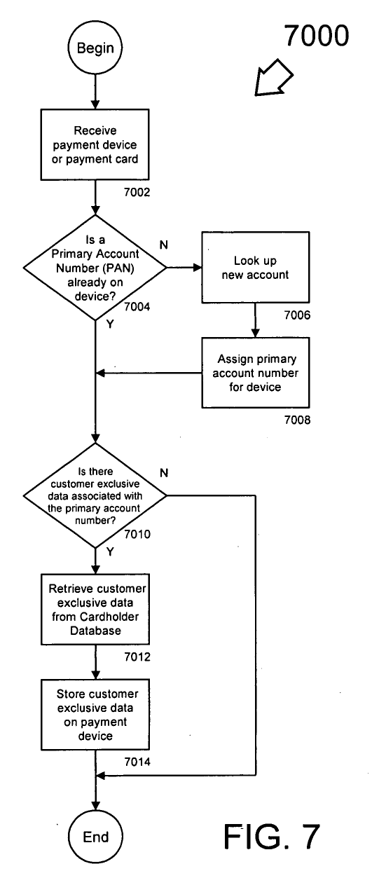

We now turn our attention to method or process embodiments of the present invention, FIGS. 7-9. It is understood by those known in the art that instructions for such method embodiments may be stored on their respective computer-readable memory 2300 and executed by their respective processors 2100.

FIG. 7 is a flow chart describing the initial storage of customer exclusive data 4000 on a payment card or device, in accordance with an embodiment of the present invention. For the purposes of this example, it is assumed that the customer exclusive data 4000 is stored by payment processor 2000, although the method equally applies in embodiments implemented at issuer 1300.

At block 7002, customer data manager 2116 receives payment device 100. If a primary account number (PAN) is already electronically stored or physically imprinted on the device 100, as determined at decision block 7004, flow continues at block 7010. If no primary account number is already stored on the device 100, a new account is looked up at block 7006, and a new primary account number is assigned to device 100, block 7008.

Customer data manager 2116 queries cardholder database 2310 to see if any customer exclusive data 4000 is associated with the primary account number, block 7010. The associated customer exclusive data 4000 is retrieved from the cardholder database 2310, block 7012, and stored at the payment device 100, block 7014. Process 7000 ends.

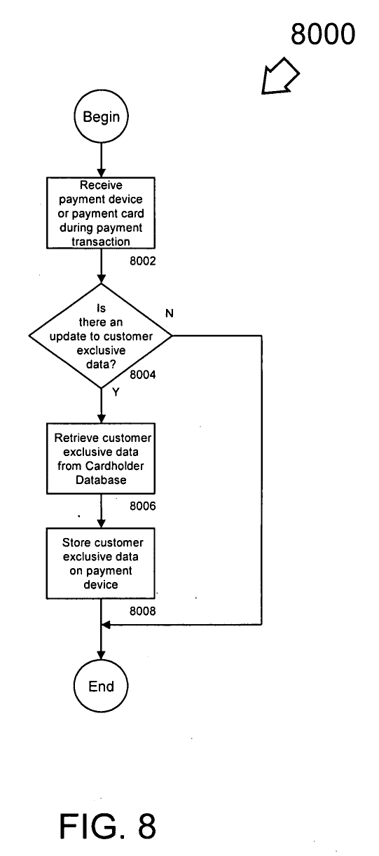

FIG. 8 is a flow chart showing the update of customer exclusive data on a payment card or device 100, constructed and operative in accordance with an embodiment of the present invention. It is understood by those familiar with the art, that process 8000 occurs at merchant 1100 in communication with payment processor 2000, and merchant 1100 has a transceiver/scanner able to encode information on payment device 100.

Process 8000 begins when the financial transaction is received at merchant 1100. At block 8002, a point-of-sale read/writer device receives transaction data from the payment device 100. The transaction data may be received as part of an authorization request or customer inquiry, as a customer uses payment device 100 to pay for a financial transaction. The transaction data is received via a card transceiver/scanner and includes information such as the primary account number. Usually, a payment device's Primary Account Number is either a 15 or 16 digit number. The first six digits of a Visa™ or MasterCard™ Primary Account Number identifies the card issuer banking institution 1300 and is known as the “Bank Identification Number” or “BIN.” In some embodiments, such as debit transactions, the authorization request may also contain a user verification identifier, such as the customer's personal identification number (PIN) or biometric information.

At decision block 2004, fraud prevention engine 2110 determines whether the customer exclusive data 4000 associated with the primary account number needs to be updated. An update may occur, for example, because the new customer exclusive data 4000 exists as issuer 1300 receives new information from the payment device user.

The associated customer exclusive data 4000 is retrieved from the cardholder database 2310, block 8006, and stored at the payment device 100, block 8008.

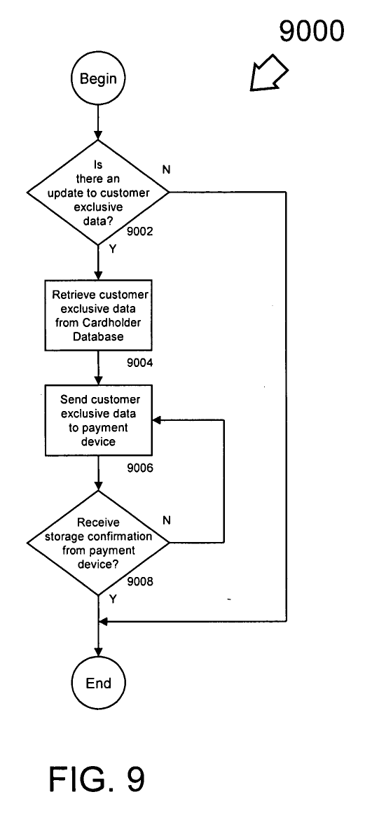

FIG. 9 depicts process 9000, the update of customer exclusive data on a wireless payment device/phone 100c via a mobile telephony interface 2400, constructed and operative in accordance with an embodiment of the present invention.

At block 8002, customer data manager 2116 queries cardholder database 2310 to see if any customer exclusive data 4000 associated with wireless payment device 100c needs updating. The associated customer exclusive data 4000 is retrieved from the cardholder database 2310, block 9004, and is transmitted to the payment device 100c via mobile telephony interface 2400, block 9006.

If at decision block 9008 a “receive storage confirmation” is received from the payment device 100c, process 7000 ends. Otherwise, process flow returns to block 9006.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

1. A method of encoding a payment device, the payment device having a primary account number, the method comprising:
querying a cardholder database with the primary account number to determine whether there is customer exclusive data associated with the primary account number;
storing the customer exclusive data on to the payment device at a point-of-sale.

2. The method of claim 1, wherein the customer exclusive data is stored in Tag-Length-Value format.

3. The method of claim 2, wherein the customer exclusive data is a data element within Field 55.

4. The method of claim 3, wherein the customer exclusive data is data element 9F7C.

5. The method of claim 4, wherein the customer exclusive data includes loyalty, rewards, contact or discretionary data.

6. The method of claim 5, wherein the storing of the customer data on to the payment device is via a wireless or contactless interface.

7. The method of claim 5, further comprising:
re-storing the customer exclusive data on to the payment device if a confirmation is not received.

8. A payment card encoding system, comprising:
a cardholder database containing a primary account number, the primary account number associated with customer exclusive data;
a customer data manager configured to query the cardholder database with the primary account number to determine whether there is customer exclusive data associated with the primary account number, the customer data manager configured to further send the customer exclusive data for storage on a payment device at a point-of-sale.

9. The system of claim 8, wherein the customer exclusive data is stored in Tag-Length-Value format.

10. The system of claim 9, wherein the customer exclusive data is a data element within Field 55.

11. The system of claim 10, wherein the customer exclusive data is data element 9F7C.

12. The system of claim 11, wherein the customer exclusive data includes loyalty, rewards, contact or discretionary data.

13. The system of claim 12, wherein the storing of the customer data on to the payment device is via a wireless or contactless interface.

14. The system of claim 12, wherein the customer data manager re-stores the customer exclusive data on to the payment device if a confirmation is not received.

15. The system of claim 14, further comprising:
a card transceiver/scanner configured to receive the customer exclusive data from the customer data manager, and to store the customer exclusive data on to the payment device.

16. The system of claim 14, further comprising:
a mobile telephony interface configured to receive the customer exclusive data from the customer data manager, and to transmit the customer exclusive data to the payment device.

17. A computer-readable medium, encoded with data and instructions, that when executed by a computing-device causes the computing device to:
query a cardholder database with the primary account number to determine whether there is customer exclusive data associated with the primary account number;
store the customer exclusive data on to the payment device at a point-of-sale.

18. The computer-readable medium of claim 17, wherein the customer exclusive data is stored in Tag-Length-Value format.

19. The computer-readable medium of claim 18, wherein the customer exclusive data is a data element within Field 55.

20. The computer-readable medium of claim 19, wherein the customer exclusive data is data element 9F7C.
